(19) United States
(12) Patent Application Publication
(10) Pub. No.: US 2008/0087116 A1
(43) Pub. Date: Apr. 17, 2008

(54) Level sensor with redundant accelerometers

(76) Inventors: Bernard J. Rate, Portland, OR (US); Andy K. Lim, Tigard, OR (US); Dennis J. Bonciolini, Tigard, OR (US)

Correspondence Address: Christopher R. Chistenson;WESTMAN, CHAMPLIN & KELLY, P.A., Suite 1400, 900 Second Avenue South, Minneapolis, MN, 55402-3319, US

(21) Appl. No.: 11/904,626

(22) Filed: Sep. 27, 2007

Related U.S. Application Data
(60) Provisional application No. 60/848,773, filed on Oct. 2, 2006.

(51) Int. Cl. G01M 19/00

(52) U.S. Cl. 73/865.9

(57) ABSTRACT

An acceleration measurement system is provided. The system includes at least first and second accelerometers. The first accelerometer has an electrical characteristic that varies with acceleration in a first axis. The second accelerometer also has an electrical characteristic that varies with acceleration in the same first axis. A controller is operably coupled to the first and second accelerometers and provides an acceleration output that is based on the electrical characteristics of the first and second accelerometers. In one aspect, the acceleration system is in the form of a substrate-like sensor.

### CROSS-REFERENCE TO RELATED APPLICATION

The present application is based on and claims the benefit of U.S. provisional patent application Ser. No. 60/848,773, filed Oct. 2, 2006, the content of which is hereby incorporated by reference in its entirety.

### BACKGROUND

Semiconductor processing systems are characterized by extremely clean environments and extremely precise semiconductor wafer movement. Industries place extensive reliance upon high-precision robotic systems to move substrates, such as semiconductor wafers, about the various processing stations within a semiconductor processing system with the requisite precision.

Reliable and efficient operation of such robotic systems depends on precise positioning, alignment, and/or parallelism of the components. Accurate wafer location minimizes the chance that a wafer may accidentally scrape against the walls of a wafer processing system. Accurate wafer location on a process pedestal in a process chamber may be required to optimize the yield of that process. Precise parallelism between surfaces within the semiconductor processing system is important to ensure that minimal substrate sliding or movement occurs during transfer from a robotic end effector to wafer carrier shelves, pre-aligner vacuum chucks, load lock elevator shelves, process chamber transfer pins and/or pedestals. When a wafer slides against a support, particles may be scraped off that cause yield loss. Misplaced or misaligned components, even on the scale of fractions of a millimeter, can impact the cooperation of the various components within the semiconductor processing system, causing reduced product yield and/or quality.

This precise positioning must be achieved in initial manufacture, and must be maintained during system use. Component positioning can be altered because of normal wear, or as a result of procedures for maintenance, repair, alteration, or replacement. Accordingly, it becomes very important to automatically measure and compensate for relatively minute positional variations in the various components of a semiconductor processing system.

In the past, attempts have been made to provide substrate-like sensors in the form of a substrate, such as a wafer, which can be moved through the semiconductor processing system to wirelessly convey information such as substrate inclination and acceleration within the semiconductor system. One particular example of such a system is shown in U.S. Pat. No. 6,266,121 to Reginald Hunter. That system includes an inclinometer that has a cavity that is partially filled with a conductive fluid, such as mercury, and an array of probes disposed vertically in the cavity into the conductive fluid. Additionally, the system of the '121 patent provides an accelerometer that mounts to the support platform and senses the acceleration of the sensor device.

High accuracy accelerometers used for level sensing tend to be relatively expensive and large, most notably in the z-axis, because they contain large moving parts. The utilization of bulky accelerometers, such as bulky electrolytic accelerometers, or large microelectromechanical system (MEMS) accelerometers can provide a high signal-to-noise (S/N) ratio, but demand large vertical z-axis space. Additionally, these accelerometers are generally relatively costly and increase the overall cost of the substrate-like sensor.

Given that a substrate-like sensor must, by virtue of its design, be able to move through a semiconductor processing system in the same way that a substrate does, it is imperative that the substrate-like sensor not exceed the physical envelope allowed for the substrate. Common wafer dimensions and characteristics may be found in the following specification: SEMI M1-0302, “Specification for Polished Monochrystoline Silicon Wafers”, Semiconductor Equipment and Materials International, www.semi.org. The selection of the accelerometer for use with the substrate-like sensor is constrained by the issue of cost as well as the height of the overall accelerometer. Providing an accelerometer system that is low-cost, and extremely low-profile would provide significant advantages to the art of wireless substrate-like sensing.

### SUMMARY

An acceleration measurement system is provided. The system includes at least first and second accelerometers. The first accelerometer has an electrical characteristic that varies with acceleration in a first axis. The second accelerometer also has an electrical characteristic that varies with acceleration in the same first axis. A controller is operably coupled to the first and second accelerometers and provides an acceleration output that is based on the electrical characteristics of the first and second accelerometers. In one aspect, the acceleration system is in the form of a substrate-like sensor.

### BRIEF DESCRIPTION OF THE DRAWINGS

FIG. 1 is a perspective view of a wireless substrate-like sensor with which embodiments of the present invention are particularly useful.

FIG. 2 is a block diagram of a wireless substrate-like sensor in accordance with an embodiment of the present invention.

FIG. 3 is a diagrammatic view of a number of individual accelerometers.

FIG. 4 is a schematic diagram of four individual accelerometers being electrically coupled in such a manner that their output, combined electronically, is more accurate.

### DETAILED DESCRIPTION

Embodiments of the present invention generally provide a plurality of relatively low-cost, low-height accelerometers arranged such that at least two accelerometers are responsive to acceleration in the same axis. This arrangement allows multiple low-cost accelerometers to provide a more accurate signal, with a higher signal-to-noise ratio than would be available from each sensor individually. Moreover, the overall cost of the plurality of low-cost sensors, as well as the height required to house such sensors is believed to be beneficial for wireless substrate-like sensors.

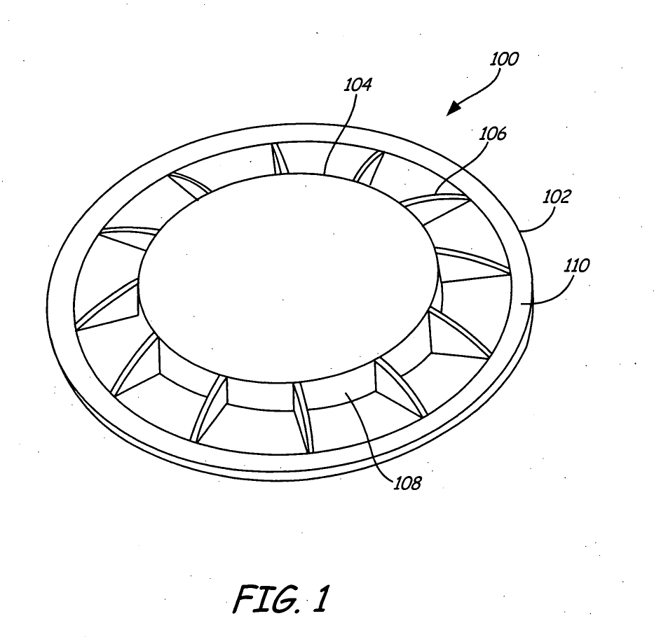

FIG. 1 is a perspective view of a wireless substrate-like sensor with which embodiments of the present invention are particularly useful. Sensor 100 includes substrate-like portion 102 that is preferably sized to have a diameter that is equal to that of a standard substrate size. Exemplary sizes include a 200 millimeter diameter, or a 300 millimeter diameter. However, as different standards are developed or employed, this dimension can vary. Sensor 100 includes electronics housing or enclosure 104 that is disposed upon substrate-like portion 102. In order to increase the rigidity of the overall sensor 100, a plurality of fins or struts 106 are provided that couple side wall 108 of electronics enclosure 104 to surface 110 of substrate-like portion 102. In order to pass easily through the sealed semiconductor processing chamber, it is necessary for substrate-like sensor 102 to have a form factor, including an overall height, that is very similar, if not identical, to an actual substrate.

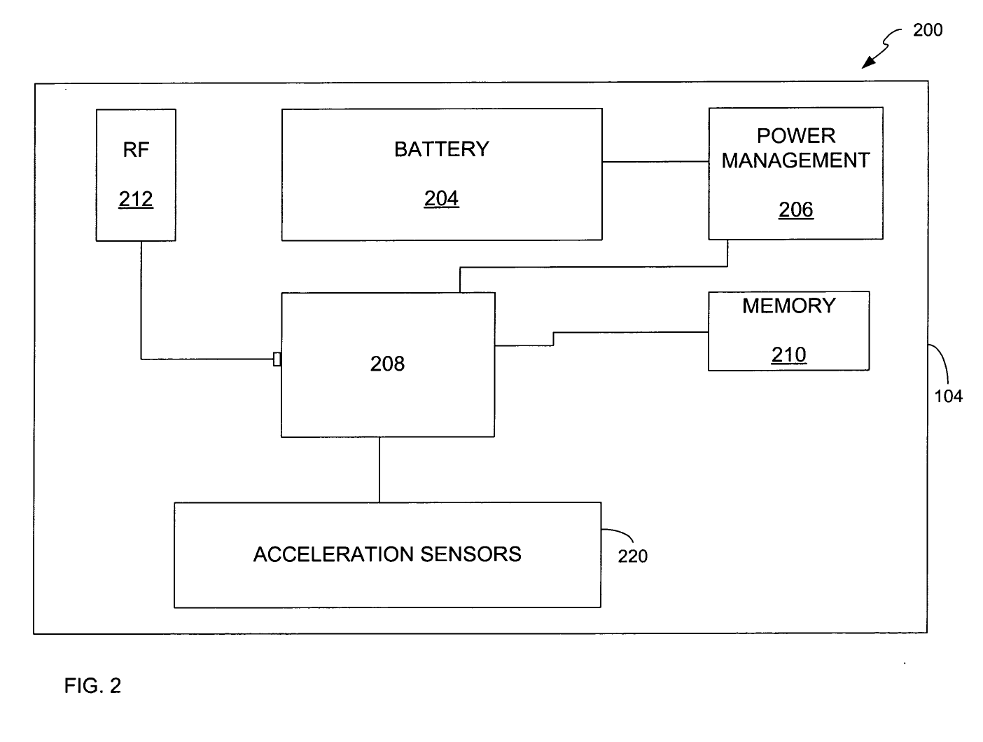

FIG. 2 is a block diagram of a wireless substrate-like sensor in accordance with an embodiment of the present invention. Sensor 200 includes electronics enclosure 104, which houses battery 204, power management module 206, and controller 208, radio-frequency module 212, and memory 210.

While acceleration sensors 220 are illustrated in FIG. 2 within enclosure 104, they may form part of enclosure 104, or may be disposed proximate, but external to enclosure 104.

As illustrated in FIG. 2, battery 204 is preferably disposed within enclosure 104 and is coupled to controller 208 via power management module 206. Preferably, power management module 206 is a power management integrated circuit available from Linear Technology Corporation under the trade designation LTC3443. Controller 208 is preferably a microprocessor available from Texas Instruments under the trade designation MSC1211Y5. Controller 208 is coupled to memory module 210, which can take the form of any type of memory, including memory that is internal to controller 208 as well as memory that is external to controller 208. The preferred controller includes internal SRAM, flash RAM and boot ROM. Memory module 210 also preferably includes external flash memory having a size of 64K×8. Flash memory is useful for storing such non-volatile data as programs, calibration data, and/or non-changing data as may be required. The internal random access memory is useful for storing volatile data relevant to program operation.

Controller 208 is coupled via a suitable port, such as a serial port, to radio frequency communication module 212 in order to communicate with external devices. In one embodiment, radio-frequency module 212 operates in accordance with the well-known Bluetooth standard, Bluetooth core specification version 1.1 (Feb. 22, 2001), available from the Bluetooth SIG (www.bluethooth.com). One example of module 212 is available form Mitsumi under the trade designation WMLC40. Additionally, other forms of wireless communication can be used in addition to, or instead of, module 212. Suitable examples of such wireless communication include any other form of radio frequency communication, acoustic communication, infrared communication or even communication employing magnetic induction.

Controller 208 is coupled to acceleration sensors 220 and senses acceleration experienced by the wireless substrate-like sensor. Such acceleration may include that caused by physical movements of the wireless substrate-like sensor, the force and orientation of gravity, or a combination thereof.

Acceleration sensor module 220 includes a plurality of individual accelerometers where at least two acceleration sensors are arranged to be responsive to acceleration in the same direction. In this manner, the at least two accelerometers are considered redundant. Preferably, each of these individual accelerometers is a relatively low-cost, low-profile accelerometer. By utilizing a plurality of such sensors, in parallel, the result is a higher accuracy accelerometer that does not require a large-z-axis space. Preferably, each such accelerometer is a MEMS accelerometer. In theory, is believed that the internal noise of a low-cost MEMS accelerometer is approximately a Gaussian function distribution, and that by paralleling N such devices, the overall signal-to-noise ratio of the resulting sensor is improved by the square root of N. For example, an array of 16 redundant accelerometers arranged in parallel would show a signal-to-noise ratio improvement of 4. Further, if the noise distribution is not Gaussian, but is more limited in amplitude, then the improvement could be even greater.

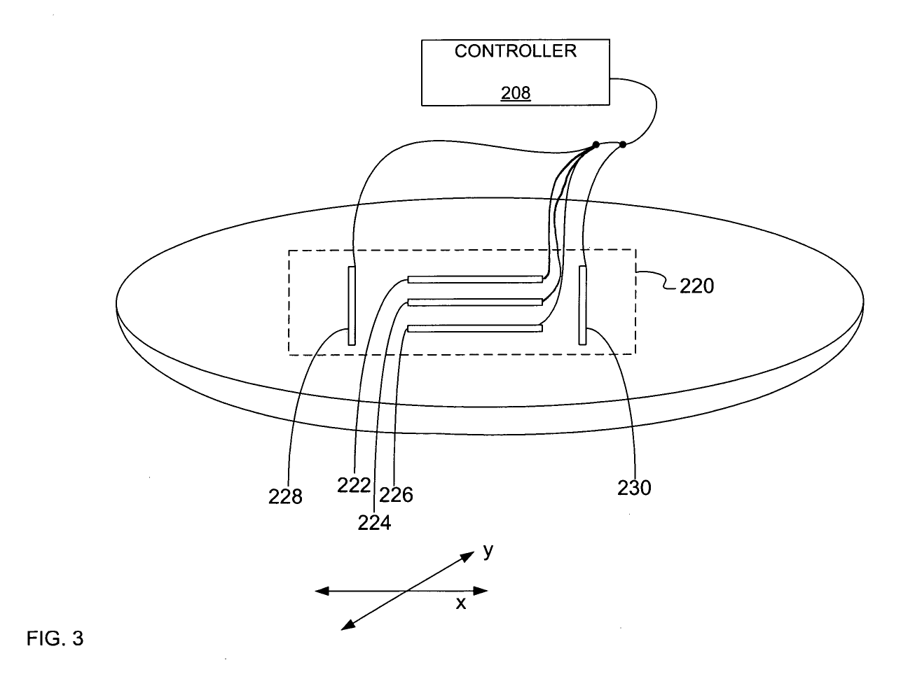

FIG. 3 is a diagrammatic view of a number of individual accelerometers comprising module 220. Specifically, module 220 includes 3 accelerometers 222, 224, 226 that are arranged to be responsive to acceleration in substantially the same orientation. Additionally, module 220 includes a plurality of sensors 228, 230 that are arranged to sense acceleration in another, orthogonal, direction. The number of individual MEMS sensors illustrated in FIG. 3 is arbitrary, and is intended to illustrate the utilization of a plurality of individual accelerometers arranged to sense acceleration in the same direction. Each of the various accelerometers 222, 224, 226, 228, 230 is coupled to controller 208. Controller 208, either through circuitry, or computation, is able to use the individual signals from the various accelerometers, 222, 224, 226, 228, 230 and provide a acceleration output that is more accurate, and has a larger signal-to-noise ratio than that produced by each of the accelerometers alone.

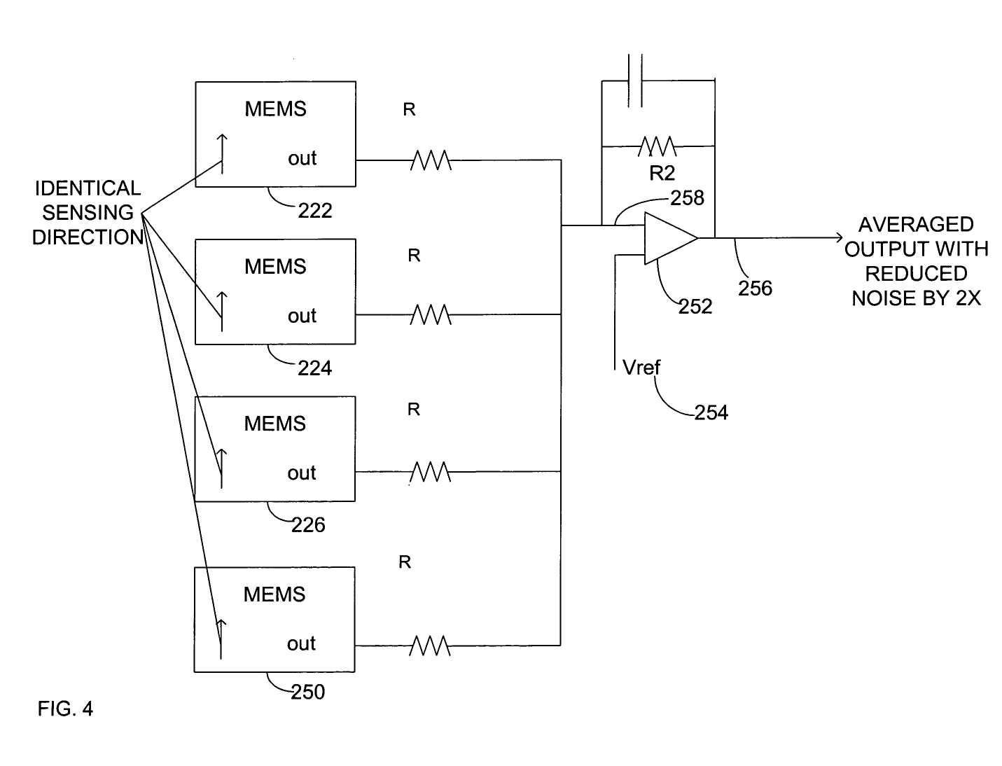

FIG. 4 is a schematic diagram of four individual accelerometers being electrically coupled in such a manner that their output, combined electronically, is more accurate. FIG. 4 illustrates the three accelerometers 222, 224, 226 illustrated with respective to FIG. 3 as well as additional accelerometer 250 (not shown in FIG. 3). Each of accelerometers 222, 224, 226 and 250 is responsive to acceleration in the same direction. Each of the accelerometers is wired in series with a resistor and operably coupled to an input of operational amplifier 252. Reference voltage 254 is supplied to the other input of amplifier 252. Additionally, a capacitance and resistance (R2) are coupled in parallel and between output 256 of operational amplifier 252 and input 258. The resultant output on line 256 is essentially an averaged output with reduced noise by approximately a factor of 2. As set forth above, increasing the number of individual accelerometers will further reduce the noise on output 256. Output 256 is then coupleable directly to controller 208, or to suitable measurement circuitry, such as an analog-to-digital converter, which would then be coupled to controller 208. Preferably, all of the accelerometers used in accordance with embodiments of the present invention are formed of the same material. In this manner, any temperature change will affect all of the accelerometers equally.

Although the present invention has been described with reference to preferred embodiments, workers skilled in the art will recognize that changes may be made in form and detail without departing from the spirit and scope of the invention.

What is claimed is:

1. An acceleration measurement system comprising:
a first accelerometer having an electrical characteristic that varies with acceleration in a first axis;
a second accelerometer having an electrical characteristic that varies with acceleration in the first axis; and
a controller operably coupled to the first and second accelerometers, the controller providing an acceleration output that is based on the electrical characteristics of the first and second accelerometers.

2. The acceleration system of claim 1, and further comprising a third accelerometer having an electrical characteristic that varies with acceleration in a second axis.

3. The system of claim 2, wherein the second axis is perpendicular to the first axis.

4. The system of claim 2, wherein and further comprising a fourth accelerometer having an electrical characteristic that varies with acceleration in the second axis.

5. The system of claim 4, wherein all accelerometers are formed of the same material.

6. The system of claim 1, wherein the first and second accelerometers are MEMS devices.

7. A substrate-like sensor comprising:
a substrate-like portion sized to resemble a substrate;
an electronics enclosure coupled to the substrate-like portion;
a first accelerometer having an electrical characteristic that varies with acceleration in a first axis;
a second accelerometer having an electrical characteristic that varies with acceleration in the first axis; and
a controller disposed within the electronics enclosure, the controller being operably coupled to the first and second accelerometers, the controller providing an acceleration output that is based on the electrical characteristics of the first and second accelerometers.

8. The substrate-like sensor of claim 7, and further comprising a battery disposed within the electronics enclosure and operably coupled to the controller.

9. The substrate-like sensor of claim 8, and further comprising a power management module disposed within the electronics enclosure and interposed between the controller and the battery.

10. The substrate-like sensor of claim 7, and further comprising a wireless communication module disposed within the electronics enclosure and coupled to the controller.

11. The substrate-like sensor of claim 10, wherein the wireless communication module is configures to communicate in accordance with at least one Bluetooth specification.

12. The substrate-like sensor of claim 1, wherein each of the first and second accelerometers is operably coupled to an input of an operational amplifier.

13. The substrate-like sensor of claim 12, wherein the operational amplifier is coupled to a reference voltage.

14. The substrate-like sensor of claim 12, wherein each accelerometer is arranged in series with a resistor.

15. The substrate-like sensor of claim 12, wherein the operational amplifier is operably coupled to the controller.
